(19) United States
(12) Patent Application Publication
(10) Pub. No.: US 2013/0006553 A1
(43) Pub. Date: Jan. 3, 2013

(54) APPARATUS AND METHOD FOR GENERATING ANALYSIS ALGORITHM OF ELECTROMAGNETIC FIELD GENERATOR

(75) Inventors: JONG HWA KWON, Daejeon (KR); Hyo Joon EOM, Daejeon (KR); Sung Uk LEE, Daejeon (KR)

(73) Assignees: Korea Advanced Institute of Science and Technology, Daejeon (KR); Electronics and Telecommunications Research Institute, Daejeon (KR)

(21) Appl. No.: 13/421,072

(22) Filed: Mar. 15, 2012

(30) Foreign Application Priority Data
Jun. 30, 2011 (KR) 10-2011-0064682

(51) Int. Cl. G06F 19/00

(52) U.S. Cl. 702/57

(57) ABSTRACT

An analysis algorithm generation apparatus of an electromagnetic field generator includes: a value inputting unit for receiving information on a TEM cell or GTEM cell; and an algorithm generating unit for generating an algorithm to analyze a TEM mode in a cross sectional structure of the GTEM cell or a tapered section of the TEM cell by using an associated Legendre function and a mode-matching method based on the information transmitted from the value inputting unit. The algorithm generating unit analyzes the TEM mode by dividing a space into four (left, right, upper and lower) regions, the space existing between an inner electrode and an outer wall of the cross sectional structure of the GTEM cell or the tapered section of the TEM cell.

### CROSS-REFERENCE(S) TO RELATED APPLICATION(S)

The present invention claims priority of Korean Patent Application No. 10-2011-0064682, filed on Jun. 30, 2011 which is incorporated herein by reference.

### FIELD OF THE INVENTION

The present invention relates to an electromagnetic field generation technique, and more particularly, to an apparatus and a method for generating an analysis algorithm of an electromagnetic field generator which generate the analysis algorithm used in a structure analysis and design with respect to a tapered section of a TEM (Transverse Electromagnetic) cell and a GTEM (Giga hertz Transverse Electromagnetic) cell, wherein the TEM cell and the GTEM cell are used as an electromagnetic field generator in an EMC (Electromagnetic Compatibility) field.

### BACKGROUND OF THE INVENTION

Recently, with the rapid development of electronic/electrical and information techniques, a diversity of electronic devices is being produced, and therefore, we live in an environment of an electromagnetic wave noise where the various electronic devices generate a considerable amount of electromagnetic waves.

The electromagnetic waves emitted from those electronic devices may not only cause a physical disorder in a human body but also affect with each other which results in a malfunction or a breakdown of the electronic devices.

In order to solve these problems, there are attempts to suppress an emission of unnecessary electromagnetic waves to be equal to or less than a specific regulation value, and a study on the electromagnetic compatibility (EMC) is actively going on to enhance a tolerance of the electronic devices against electromagnetic waves, whereby the electronic devices can normally operate without any interference in the electromagnetic wave environment in which the electromagnetic waves are regulated to a specific regulation value.

As a measurement tool for the EMC study, electromagnetic field generators in various forms, such as a TEM cell and a GTEM cell respectively shown in FIGS. 1A and 1B, are utilized. The tapered section of the TEM cell or GTEM cell is structured in a rectangular pyramid and has a septum therein, as shown in FIGS. 1A and 1B.

FIG. 2 presents a structure of a tapered section of a TEM cell or a GTEM cell in which a septum is provided at an arbitrary position.

Referring to FIG. 2, since the tapered section of the TEM cell or the GTEM cell has the septum in a rectangular pyramid structure thereof, the tapered section of the TEM cell or the GTEM cell may generate a plane wave between the septum and an external conductor. In a case of a TEM cell or a GTEM cell having an asymmetric structure, the position of an internal electrode is switched from a center of the cell to a top end or a bottom end of the cell.

In this case, uniformity of an electromagnetic wave becomes deteriorated in comparison with a symmetric structure; however a uniform area of an electromagnetic wave, in which a target to be tested is positioned, becomes wider. Therefore, the TEM cell or the GTEM cell of the asymmetric structure may have a high useable frequency bandwidth, which is strength of the asymmetric structure. Analysis methods with respect to TEM mode and higher order mode cutoff frequencies in the GTEM cell or the TEM cell are being studied.

In the analysis method for the above-described electromagnetic field generator according to the prior art, although the variety of the analysis methods with respect to the TEM mode and higher order mode cutoff frequencies in the GTEM cell or the TEM cell is on studying, the conventional analysis method including a numerical analysis involves a great amount of calculations which results in degrading a calculation speed and a calculation correctness.

### SUMMARY OF THE INVENTION

In view of the above, the present invention provides an apparatus and a method for generating an analysis algorithm of an electromagnetic field generator, wherein the analysis algorithm is used in a structure analysis and design for a tapered section of a TEM cell and a GTEM cell which are used as the electromagnetic field generator in an EMC (Electromagnetic Compatibility) field.

The present invention further provides the apparatus and the method for generating the analysis algorithm of the electromagnetic field generator, wherein the analysis algorithm is used in the structure analysis and design with respect to a cross sectional structure of a TEM cell and GTEM cell which have a septum at an arbitrary position thereof by using a mode-matching technique.

The present invention further provides the apparatus and the method for generating the analysis algorithm of the electromagnetic field generator, wherein the algorithm is used in analyzing a TEM mode distribution in a cross sectional structure of a GTEM cell or a tapered section of a TEM cell, the cell being used as an electromagnetic field generator, by using an associated Legendre function and a mode-matching method and used for designing the structure of the TEM cell or GTEM cell based on the analysis result.

In accordance with an aspect of the present invention, there is provided an analysis algorithm generation apparatus of an electromagnetic field generator including: a value inputting unit for receiving information on a TEM cell or GTEM cell; and an algorithm generating unit for generating an algorithm to analyze a TEM mode in a cross sectional structure of the GTEM cell or a tapered section of the TEM cell by using an associated Legendre function and a mode-matching method based on the information transmitted from the value inputting unit.

In accordance with another aspect of the present invention, there is provided an analysis algorithm generation method of an electromagnetic field generator. The method includes: receiving information on a TEM cell or GTEM cell; and generating an algorithm to analyze a TEM mode in a cross sectional structure of the GTEM cell or a tapered section of the TEM cell by using an associated Legendre function and a mode-matching method based on the received information.

In accordance with the aspects of the present invention, the analysis algorithm generation apparatus and method for the electromagnetic field generator generates the algorithm for analyzing the TEM mode distribution within a cell of the cross sectional structure of the tapered structure of TEM cell or GTEM cell as the electromagnetic field generator by using the associated Legendre function and a mode-matching technique, and for designing a structure of the TEM cell or the GTEM cell. The analysis result obtained by the algorithm is a precise analytical solution and provides a rapid convergence and effective numerical calculations.

Further, since the analysis result provides a shortened analysis time as well as the precise analysis and design in comparison with the result of the conventional numerical analysis, it can be effectively applicable to a design and a performance analysis of the tapered section of the TEM cell or GTEM cell.

### BRIEF DESCRIPTION OF THE DRAWINGS

The objects and features of the present invention will become apparent from the following description of embodiments, given in conjunction with the accompanying drawings, in which:

FIGS. 1A and 1B present conventional structures of a TEM cell and a GTEM cell, respectively;

FIG. 2 shows a structure of a tapered sector of a TEM cell or a GTEM cell having a septum provided in an arbitrary position therein;

FIG. 3 depicts an algorithm generation apparatus performing a TEM mode analysis with respect to a cross sectional structure of an electromagnetic field generator in accordance with the embodiment of the present invention;

FIG. 4 presents a cross sectional structure of a GTEM cell for its cell analysis in accordance with the embodiment of the present invention;

FIGS. 5A to 5B depict the distribution of the equipotential lines and E-field distribution expressed with arrows at a cross section φ−θ, in a case of α_{d}=89.7°; and

FIGS. 6A and 6B present the distribution of the equi-potential lines and E-field distribution expressed with arrows at a cross section φ−θ, in a case of α_{d}=87°.

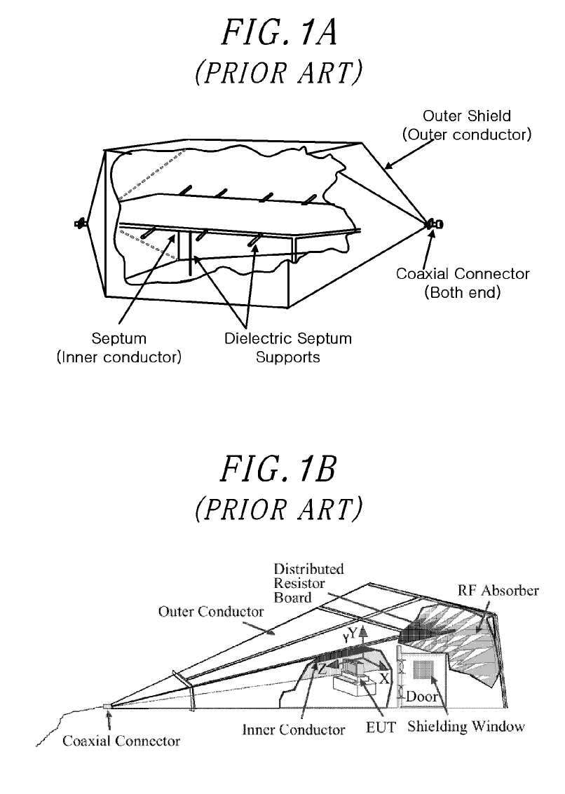

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed by user's or operator's intention for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

The embodiments of the present invention relates to generating an analysis algorithm used in a structure analysis and design with respect to a tapered section of a TEM cell and a GTEM cell in the EMC field, wherein a TEM mode distribution in the TEM cell or the GTEM cell is analyzed by using an associated Legendre function and a mode-matching method, and the structure of the TEM cell or the GTEM cell is designed based on the analysis result.

Hereinafter, embodiments of the present invention will be described in detail with reference to the accompanying drawings which form a part hereof.

FIG. 3 illustrates a block diagram of an algorithm generation apparatus 300 performing TEM mode analysis with respect to a cross sectional structure of an electromagnetic field generator in accordance with the embodiment of the present invention.

Referring to FIG. 3, the algorithm generation apparatus 300 analyzes the TEM mode distribution based on information on a TEM cell or a GTEM cell and generates an algorithm used in analyzing and designing the structure of the TEM cell or the GTEM cell based on the analysis result. The algorithm generation apparatus 300 may be algorithm generation software or one of computing devices installed with the algorithm generation software.

The algorithm generation apparatus 300 includes a value input unit 302, a value setting unit 304, a TEM mode analysis unit 306 and the like.

Specifically, the value input unit 302 receives numerical values with respect to a TEM cell or a GTEM cell, i.e., receives information on the cross sectional structure of a tapered section of the TEM cell or the GTEM cell. The information has, e.g., a width and a height of the structure of each cell, a width and a thickness of a septum provided within each cell and information whether the septum is symmetric or asymmetric.

The value setting unit 304 sets input values as well as necessary values or defined conditions by reflecting previously set numerical values or user-set numerical values.

For example, it is assumed that each of regions divided with respect to the septum in the TEM cell or the GTEM cell is formed with an air of which wave number is k (=ω\sqrt{μ₀ε₀}) and permittivity, permeability, coefficients, weight and the like in free space are set.

The TEM mode analysis unit 306 as an algorithm generation unit receives the information on the TEM cell or the GTEM cell from the value input unit 302 and the set numerical values from the value setting unit 304. Based on the information and numerical values received from the value input unit 302 and value setting unit 304, the TEM mode analysis unit 306 performs TEM mode analysis on the structure of the TEM cell or GTEM cell, i.e., the cross sectional structure of the electromagnetic field generator.

In detail, the TEM mode analysis unit 306 analyzes the TEM mode distribution within the cell by using the associated Legendre function and mode-matching method and generates an algorithm for designing a structure of the TEM cell or the GTEM cell based on the analysis result.

Then, the TEM mode analysis unit 306 transmits the generated algorithm to a cell design and performance analysis (CDPA) unit 350. The CDPA unit 350 analyzes and designs the structure of the TEM cell or the GTEM cell by using the received algorithm.

Even though the algorithm generation apparatus 300 and the CDPA unit 350 are separately presented in FIG. 3, they may be configured as one functional block in a system.

Hereinafter, an algorithm generating method in the TEM mode analysis unit 306 will be described in detail.

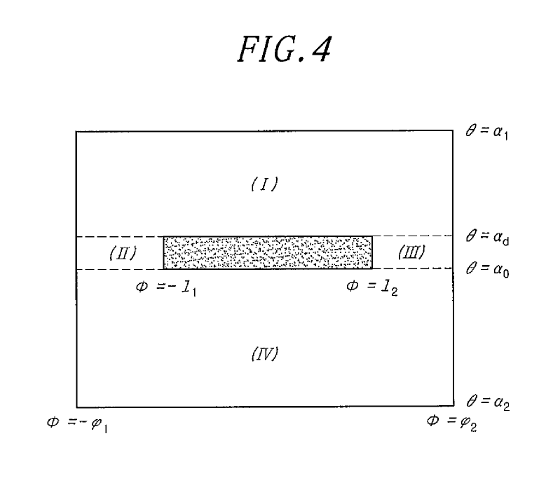

FIG. 4 shows a cross sectional view of a structure of a GTEM cell for GTEM cell analysis in accordance with the embodiment of the present invention.

In FIG. 4, the GTEM cell has a width of |φ₂+φ₁| and a height of |α₂−α₁|, and angles of φ and θ directions are assumed to be constant. In the GTEM cell, a septum, of which width and thickness are |l₂+l₁| and |α_{d}−α₀|, respectively, is provided in an arbitrary position therein. Therefore, any case of a septum which is symmetric or asymmetric can be analyzed.

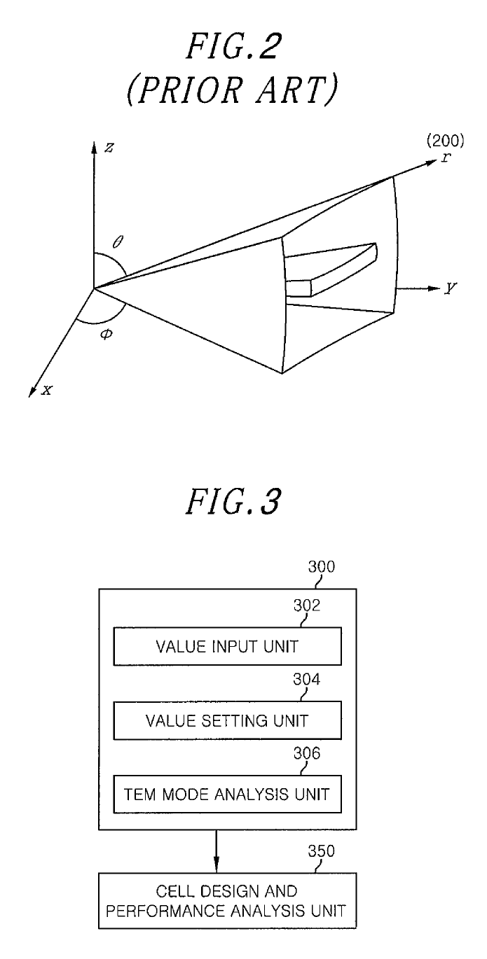

Further, the cross sectional structure of the tapered section of the TEM cell or the GTEM cell may be divided into four regions (I, II, III, and IV) to be analyzed. It is assumed that each of the regions is formed with an air of which wave number is k (=ω\sqrt{μ₀ε₀}) and traveling waves propagate in r(200) direction in the spherical coordinates system (r, θ, φ) in FIG. 2. With this, the TEM mode analysis can be performed on a cross sectional structure having a constant r of the electromagnetic field generator.

Further, in the embodiment of the present invention, the permittivity ε₀ and permeability μ₀ in the free space are described while their subscripts are omitted.

TEM waves are assumed to travel in a direction from an origin of coordination to the outside, i.e., in the r(200) direction in the coordinates system in FIG. 2. Each of the regions (I, II, III, and IV) can be expressed with an electrostatic potential Φ in detail by using Laplace's equation. The septum has a potential V₀, and the outer conductor is at zero potential.

The electrostatic potential in region I is written as an equation 1.

$${Φ}^{I} = {\sum }_{p = 1}^{∞} {A}_{p} {R}_{p} ( cos θ ) sin [ {a}_{p} ( φ + {ϕ}_{1} ) ] \\ Herein , {a}_{p} = p π / ( {ϕ}_{2} + {ϕ}_{1} ) , \\ {R}_{p} ( cos θ ) = {Q}_{0}^{{a}_{p}} ( cos {α}_{1} ) {P}_{0}^{{a}_{p}} ( cos θ ) - {P}_{0}^{{a}_{p}} ( cos {α}_{1} ) {Q}_{0}^{{a}_{p}} ( cos θ ) . \qquad [ Eq . 1 ]$$

Further, P₀^{α}^{ₚ} (COS θ) and Q₀^{α}^{ₚ} (COS θ) present first and second kinds of the associated Legendre function, respectively.

The electrostatic potential in region II is written as an equation 2.

$${Φ}^{II} = {\sum }_{s = 1}^{∞} sin [ {b}_{s} ( φ + {ϕ}_{1} ) ] [ {B}_{s} {P}_{0}^{{b}_{s}} ( cos θ ) + {C}_{s} {Q}_{0}^{{b}_{s}} ( cos θ ) ] + \frac{{V}_{0} ( φ + {ϕ}_{1} )}{{ϕ}_{1} - {l}_{1}} \qquad [ Eq . 2 ]$$

Herein, bₛ=sπ/(φ₁−l₁).

The electrostatic potential in region III is expressed as equation 3.

$${Φ}^{III} = {\sum }_{r = 1}^{∞} [ {D}_{r} {P}_{0}^{{c}_{r}} ( cos θ ) + {E}_{r} {Q}_{0}^{{c}_{r}} ( cos θ ) ] sin [ {c}_{r} ( φ - {l}_{2} ) ] - \frac{{V}_{0} ( φ - {ϕ}_{2} )}{{ϕ}_{2} - {l}_{2}} \\ Herein , {c}_{r} = r π / ( {ϕ}_{2} - {l}_{2} ) . \qquad [ Eq . 3 ]$$

The electrostatic potential in region IV is written as equation 4.

$${Φ}^{IV} = {\sum }_{p = 1}^{∞} {F}_{p} {T}_{p} ( cos θ ) sin [ {a}_{p} ( φ + {ϕ}_{1} ) ] \\ Herein \text{,} {T}_{p} ( cos θ ) = {Q}_{0}^{{a}_{p}} ( cos {α}_{2} ) {P}_{0}^{{a}_{p}} ( cos θ ) - {P}_{0}^{{a}_{p}} ( cos {α}_{2} ) {Q}_{0}^{{a}_{p}} ( cos θ ) . \qquad [ Eq . 4 ]$$

Then, electrostatic potentials of the four regions are expressed by using unknown modal coefficients Aₚ, Bₛ, Cₛ, Dᵣ, Eᵣ, and F_{P}.

The unknown modal coefficients are used to derive six simultaneous equations by applying a Dirichlet boundary condition and a Neumann boundary condition at θ=α₀ and θ=α_{d} (boundary surfaces of the septum with the I and the IV regions).

First, equation 5 presents a case where the Dirichlet boundary condition is applied among region I and regions II and III.

$${Φ}^{I} ( {α}_{d} ) = \{ \begin{matrix}{Φ}^{II} ( {α}_{d} ) & - {ϕ}_{1} \leq φ < - {l}_{1} \\ {V}_{0} & - {l}_{1} \leq φ \leq {l}_{2} \\ {Φ}^{III} ( {α}_{d} ) & {l}_{2} < φ \leq {ϕ}_{2}\end{matrix} \qquad [ Eq . 5 ]$$

When equations 1 to 3 and θ=α_{d} are applied to equation 5, equation 6 is obtained as shown below.

$$\begin{matrix}{\sum }_{p = 1}^{∞} {A}_{p} {R}_{p} ( cos {α}_{d} ) sin [ {a}_{p} ( φ + {ϕ}_{1} ) ] = {\sum }_{s = 1}^{∞} sin [ {b}_{s} ( φ + {ϕ}_{1} ) ] [ {B}_{s} {P}_{0}^{{b}_{s}} ( cos {α}_{d} ) + {C}_{s} {Q}_{0}^{{b}_{s}} ( cos {α}_{d} ) ] + \frac{{V}_{0} ( φ + {ϕ}_{1} )}{{ϕ}_{1} - {l}_{1}} \\ - {ϕ}_{1} \leq φ < - {l}_{1} \\ = {V}_{0} - {l}_{1} \leq φ \leq {l}_{2} \\ = {\sum }_{r = 1}^{∞} [ {D}_{r} {P}_{0}^{{c}_{r}} ( cos {α}_{d} ) + {E}_{r} {Q}_{0}^{{c}_{r}} ( cos {α}_{d} ) ] sin [ {c}_{r} ( φ - {l}_{2} ) ] - \frac{{V}_{0} ( φ - {ϕ}_{2} )}{{ϕ}_{2} - {l}_{2}} \\ {l}_{2} < φ \leq {ϕ}_{2}\end{matrix} \qquad [ Eq . 6 ]$$

Then, equation 7 is obtained by multiplying equation 6 by sin [a_{q}(φ+φ₁)] (q=1, 2, 3, . . . ), and integrating the multiplication result with respect to φ between −φ₁ and φ₂ (−φ₁<φ<φ₂) for utilizing the orthogonality.

$${\sum }_{p = 1}^{∞} {A}_{p} {R}_{p} ( cos {α}_{d} ) {\int }_{- {ϕ}_{1}}^{{ϕ}_{2}} sin [ {a}_{p} ( φ + {ϕ}_{1} ) sin [ {a}_{q} ( φ + {ϕ}_{1} ) ] d φ = {\sum }_{s = 1}^{∞} [ {B}_{s} {P}_{0}^{{b}_{s}} ( cos {α}_{d} ) + {C}_{s} {Q}_{0}^{{b}_{s}} ( cos {α}_{d} ) ] {\int }_{- {ϕ}_{1}}^{- {l}_{1}} sin [ {b}_{s} ( φ + {ϕ}_{1} ) ] sin [ {a}_{q} ( φ + {ϕ}_{1} ) ] d φ + {\sum }_{r = 1}^{∞} {D}_{r} {P}_{0}^{{c}_{r}} ( cos {α}_{d} ) + {E}_{r} {Q}_{0}^{{c}_{r}} ( cos {α}_{d} ) ] {\int }_{{l}_{2}}^{{ϕ}_{2}} sin [ {c}_{r} ( φ - {l}_{2} ) ] sin [ {a}_{q} ( φ + {ϕ}_{1} ) ] d φ + {\int }_{- {ϕ}_{1}}^{- {l}_{1}} \frac{{V}_{0} ( φ + {ϕ}_{1} )}{{ϕ}_{1} - {l}_{1}} sin [ {a}_{q} ( φ + {ϕ}_{1} ) ] d φ + {\int }_{- {l}_{1}}^{{l}_{2}} {V}_{0} sin [ {a}_{q} ( φ + {ϕ}_{1} ) ] d φ - {\int }_{{l}_{2}}^{{ϕ}_{2}} \frac{{V}_{0} ( φ - {ϕ}_{2} )}{{ϕ}_{2} - {l}_{2}} sin [ {a}_{q} ( φ + {ϕ}_{1} ) ] d φ \qquad [ Eq . 7 ]$$

By calculating equation 7, equation 8 is obtained.

$${\sum }_{p = 1}^{∞} {A}_{p} {R}_{p} ( cos {α}_{d} ) ( \frac{{ϕ}_{2} + {ϕ}_{1}}{2} ) {δ}_{pq} = {\sum }_{s = 1}^{∞} [ {B}_{s} {P}_{0}^{{b}_{s}} ( cos {α}_{d} ) + {C}_{s} {Q}_{0}^{{b}_{s}} ( cos {α}_{d} ) ] {G}_{sq} ( - {ϕ}_{1} , - {l}_{1} , {b}_{s} , {a}_{q} ) \qquad [ Eq . 8 ]$$

Herein, δ_{pq} is Kronecker delta,

$${G}_{sq} ( {φ}_{1} , {φ}_{2} , {b}_{s} , {a}_{q} ) = {\int }_{{φ}_{1}}^{{φ}_{2}} sin {b}_{s} ( φ - {φ}_{1} ) sin {a}_{q} ( φ + {ϕ}_{1} ) d φ , \\ \begin{matrix}{I}_{q}^{1} = {\int }_{- {ϕ}_{1}}^{- {l}_{1}} \frac{{V}_{0} ( φ + {ϕ}_{1} )}{{ϕ}_{1} - {l}_{1}} sin [ {a}_{q} ( φ + {ϕ}_{1} ) ] d φ \\ = \frac{{V}_{0}}{{a}_{q}^{2} ( {ϕ}_{1} - {l}_{1} )} [ {a}_{q} ( {l}_{1} - {ϕ}_{1} ) cos [ {a}_{q} ( {ϕ}_{1} - {l}_{1} ) ] + sin [ {a}_{q} ( {ϕ}_{1} - {l}_{1} ) ] ] ,\end{matrix}$$

$$\begin{matrix}{I}_{q}^{2} = {\int }_{{l}_{2}}^{{ϕ}_{2}} \frac{{V}_{0} ( φ - {ϕ}_{2} )}{{ϕ}_{2} - {l}_{2}} sin [ {a}_{q} ( φ + {ϕ}_{1} ) ] d φ \\ = \frac{{V}_{0}}{{a}_{q}^{2} ( {l}_{2} - {ϕ}_{2} )} [ \begin{matrix}- {a}_{q} ( {l}_{2} - {ϕ}_{2} ) cos [ {a}_{q} ( {l}_{2} + {ϕ}_{1} ) ] + \\ sin [ {a}_{q} ( {l}_{2} + {ϕ}_{1} ) ] - sin [ {a}_{q} ( {ϕ}_{1} + {ϕ}_{2} ) ]\end{matrix} ] ,\end{matrix}$$

$${P}_{q} = {\int }_{- {l}_{1}}^{{l}_{2}} {V}_{0} sin [ {a}_{q} ( φ + {ϕ}_{1} ) ] d φ = \frac{{V}_{0}}{{a}_{q}} [ cos [ {a}_{q} ( {ϕ}_{1} - {l}_{1} ) ] - cos [ {a}_{q} ( {l}_{2} + {ϕ}_{1} ) ] ] .$$

Equation 9 presents a case where the Dirichlet boundary condition is applied among region IV and regions II and III.

$${Φ}^{IV} ( {α}_{0} ) = \{ \begin{matrix}{Φ}^{II} ( {α}_{0} ) & - {ϕ}_{1} \leq φ < - {l}_{1} \\ {V}_{0} & - {l}_{1} \leq φ \leq {l}_{2} \\ {Φ}^{III} ( {α}_{0} ) & {l}_{2} < φ \leq {ϕ}_{2}\end{matrix} \qquad [ Eq . 9 ]$$

When equations 2 to 4 and θ=α₀ are applied to equation 9, equation 10 is obtained as described below.

$$\begin{matrix}{\sum }_{p = 1}^{∞} {F}_{p} {T}_{p} ( cos {α}_{0} ) sin [ {a}_{p} ( φ + {ϕ}_{1} ) ] = {\sum }_{s = 1}^{∞} sin [ {b}_{s} ( φ + {ϕ}_{1} ) ] \\ [ {B}_{s} {P}_{0}^{{b}_{s}} ( cos {α}_{0} ) + \\ {C}_{s} {Q}_{0}^{{b}_{s}} ( cos {α}_{0} ) ] + \\ \frac{{V}_{0} ( φ + {ϕ}_{1} )}{{ϕ}_{1} - {l}_{1}} - {ϕ}_{1} \leq φ < - {l}_{1} \\ = {V}_{0} - {l}_{1} \leq φ \leq {l}_{2} \\ = {\sum }_{r = 1}^{∞} [ {D}_{r} {P}_{0}^{{c}_{r}} ( cos {α}_{0} ) + \\ {E}_{r} {Q}_{0}^{{c}_{r}} ( cos {α}_{0} ) ] sin [ {c}_{r} ( φ - {l}_{2} ) ] - \\ \frac{{V}_{0} ( φ - {ϕ}_{2} )}{{ϕ}_{2} - {l}_{2}} {l}_{2} < φ \leq {ϕ}_{2}\end{matrix} \qquad [ Eq . 10 ]$$

Thereafter, equation 11 is obtained by multiplying equation 10 by sin [+_{q}(φ+φ₁)] (q=1, 2, 3, . . . ) and integrating the multiplication result with respect to φ between −φ₁ and φ₂ (−φ₁<φ<φ₂) for utilizing the orthogonality.

$${\sum }_{p = 1}^{∞} {F}_{p} {T}_{p} ( cos {α}_{0} ) {\int }_{- {ϕ}_{1}}^{{ϕ}_{2}} sin [ {a}_{p} ( φ + {ϕ}_{1} ) sin [ {a}_{q} ( φ + {ϕ}_{1} ) ] d φ = {\sum }_{s = 1}^{∞} [ {B}_{s} {P}_{0}^{{b}_{s}} ( cos {α}_{0} ) + {C}_{s} {Q}_{0}^{{b}_{s}} ( cos {α}_{0} ) ] {\int }_{- {ϕ}_{1}}^{- {l}_{1}} sin [ {b}_{s} ( φ + {ϕ}_{1} ) ] sin [ {a}_{q} ( φ + {ϕ}_{1} ) ] d φ + {\sum }_{r = 1}^{∞} {D}_{r} {P}_{0}^{{c}_{r}} ( cos {α}_{0} ) + {E}_{r} {Q}_{0}^{{c}_{r}} ( cos {α}_{0} ) ] {\int }_{{l}_{2}}^{{ϕ}_{2}} sin [ {c}_{r} ( φ - {l}_{2} ) ] sin [ {a}_{q} ( φ + {ϕ}_{1} ) ] d φ + {\int }_{- {ϕ}_{1}}^{- {l}_{1}} \frac{{V}_{0} ( φ + {ϕ}_{1} )}{{ϕ}_{1} - {l}_{1}} sin [ {a}_{q} ( φ + {ϕ}_{1} ) ] d φ + {\int }_{- {l}_{1}}^{{l}_{2}} {V}_{0} sin [ {a}_{q} ( φ + {ϕ}_{1} ) ] d φ - {\int }_{{l}_{2}}^{{ϕ}_{2}} \frac{{V}_{0} ( φ - {ϕ}_{2} )}{{ϕ}_{2} - {l}_{2}} sin [ {a}_{q} ( φ + {ϕ}_{1} ) ] d φ \qquad [ Eq . 11 ]$$

By calculating equation 11, equation 12 is obtained.

$${\sum }_{p = 1}^{∞} {F}_{p} {T}_{p} ( cos {α}_{0} ) ( \frac{{ϕ}_{2} + {ϕ}_{1}}{2} ) {δ}_{pq} = {\sum }_{s = 1}^{∞} [ {B}_{s} {P}_{0}^{{b}_{s}} ( cos {α}_{0} ) + {C}_{s} {Q}_{0}^{{b}_{s}} ( cos {α}_{0} ) ] {G}_{sq} ( - {ϕ}_{1} , - {l}_{1} , {b}_{s} , {a}_{q} ) + {\sum }_{r = 1}^{∞} [ {D}_{r} {P}_{0}^{{c}_{r}} ( cos {α}_{0} ) + {E}_{r} {Q}_{0}^{{c}_{r}} ( cos {α}_{0} ) ] {G}_{rq} ( {l}_{2} , {ϕ}_{2} , {c}_{r} , {a}_{q} ) + {I}_{q}^{1} + {P}_{q} - {I}_{q}^{2} \qquad [ Eq . 12 ]$$

Further, equation 13 presents a case where the Neumann boundary condition (∂Φ/∂θ) is applied between regions I and II.

$$\frac{\partial {Φ}^{I} ( θ )}{\partial θ} {\vert}_{θ = {α}_{d}} = \frac{\partial {Φ}^{II} ( θ )}{\partial θ} {\vert}_{θ = {α}_{d}} ( - {ϕ}_{1} < φ < - {l}_{1} ) \qquad [ Eq . 13 ]$$

Then, equation 13 is substituted with equations 1 and 2 and is differentiated with respect to θ. Then, the differentiated equation is applied with θ=α_{d} to obtain equation 14.

$${\sum }_{p = 1}^{∞} {{A}_{p} [ {R}_{p} ( cos {α}_{d} ) ]}^{′} sin [ {a}_{p} ( φ + {ϕ}_{1} ) ] = - {\sum }_{s = 1}^{∞} sin ( {α}_{d} ) sin [ {b}_{s} ( φ + {ϕ}_{1} ) ] [ {B}_{s} {P}_{0}^{{b}_{s} ′} ( cos {α}_{d} ) + {C}_{s} {Q}_{0}^{{b}_{s} ′} ( cos {α}_{d} ) ] \\ where , \\ {P}_{o}^{{b}_{s} ′} ( cos {α}_{d} ) = d {P}_{0}^{{b}_{s}} ( cos θ ) / d ( cos θ ) {\vert}_{θ = {α}_{d}} , \\ {Q}_{0}^{{b}_{s} ′} ( cos {α}_{d} ) = d {Q}_{0}^{{b}_{s}} ( cos θ ) / d ( cos θ ) {\vert}_{θ = {α}_{d}} {and [ {R}_{p} ( cos {α}_{d} ) ]}^{′} = - sin θ [ {Q}_{0}^{{a}_{p}} ( cos {α}_{1} ) {P}_{0}^{{a}_{p} ′} ( cos θ ) - {P}_{0}^{{a}_{p}} ( cos {α}_{1} ) {Q}_{0}^{{a}_{p} ′} ( cos θ ) ] {\vert}_{θ = {α}_{d}} . \qquad [ Eq . 14 ]$$

Thereafter, equation 15 is obtained by multiplying equation 14 by sin [b_{q}(φ+φ₁)] (q=1, 2, . . . ∞) and integrating the multiplication result with respect to φ between −φ₁ and −l₁ (−φ₁<φ<−l₁) for utilizing the orthogonality.

$$\begin{matrix}{\sum }_{p = 1}^{∞} {{A}_{p} [ {R}_{p} ( cos {α}_{d} ) ]}^{′} {\int }_{- {ϕ}_{1}}^{- {l}_{1}} sin [ {a}_{p} ( φ + {ϕ}_{1} ) ] sin [ {b}_{q} ( φ + {ϕ}_{1} ) ] d φ = - {\sum }_{s = 1}^{∞} sin ( {α}_{d} ) [ {B}_{s} {P}_{0}^{{b}_{s} ′} ( cos {α}_{d} ) + {C}_{s} {Q}_{0}^{{b}_{s} ′} ( cos {α}_{d} ) ] {\int }_{- {ϕ}_{1}}^{- {l}_{1}} sin [ {b}_{s} ( φ + {ϕ}_{1} ) ] sin [ {b}_{q} ( φ + {ϕ}_{1} ) ] d φ \\ By calculating equation 15 , equation 16 is obtained . & [ Eq . 15 ] \\ {\sum }_{p = 1}^{∞} {{A}_{p} [ {R}_{p} ( cos {α}_{d} ) ]}^{′} {G}_{qp} ( - {ϕ}_{1} , - {l}_{1} , {b}_{q} , {a}_{p} ) = - {\sum }_{s = 1}^{∞} sin ( {α}_{d} ) [ {B}_{s} {P}_{0}^{{b}_{s} ′} ( cos {α}_{d} ) + {C}_{s} {Q}_{0}^{{b}_{s} ′} ( cos {α}_{d} ) ] ( \frac{{ϕ}_{1} - {l}_{1}}{2} ) {δ}_{sq} & [ Eq . 16 ]\end{matrix}$$

Further, equation 17 presents a case where the Neumann boundary condition (∂Φ/∂θ) is applied between regions I and III.

$$\frac{\partial {Φ}^{I} ( θ )}{\partial θ} {\vert}_{θ = {α}_{d}} = \frac{\partial {Φ}^{III} ( θ )}{\partial θ} {\vert}_{θ = {α}_{d}} ( {l}_{2} < φ < {ϕ}_{2} ) \qquad [ Eq . 17 ]$$

Then, equation 17 is substituted with equations 1 and is differentiated with respect to θ. The differentiated equation is applied with θ=α_{d} to obtain equation 18.

$${\sum }_{p = 1}^{∞} {{A}_{p} [ {R}_{p} ( cos {α}_{d} ) ]}^{′} sin [ {a}_{p} ( φ + {ϕ}_{1} ) ] = - {\sum }_{r = 1}^{∞} sin ( {α}_{d} ) [ {D}_{r} {P}_{0}^{{c}_{r} ′} ( cos ( {α}_{d} ) ) + {E}_{r} {Q}_{0}^{{c}_{r} ′} ( cos ( {α}_{d} ) ] sin [ {c}_{r} ( φ - {l}_{2} ) ] \qquad [ Eq . 18 ]$$

Thereafter, equation 19 is obtained by multiplying equation 18 by sin [c_{q}(φ−l₂)] and integrating the multiplication result with respect to φ between l₂ and φ₂ (l₂<φ<φ₂) for utilizing the orthogonality.

$${\sum }_{p = 1}^{∞} {A}_{p} {\{ {R}_{p} ( cos ( {α}_{d} ) ) \}}^{′} {G}_{qp} ( {l}_{2} , {ϕ}_{2} , {c}_{q} , {a}_{p} ) = - {\sum }_{r = 1}^{∞} sin ( {α}_{d} ) [ {D}_{r} {P}_{0}^{{c}_{r} ′} ( cos ( {α}_{d} ) ) + {E}_{r} {Q}_{0}^{{c}_{r} ′} ( cos ( {α}_{d} ) ) ] ( \frac{{ϕ}_{2} - {l}_{2}}{2} ) {δ}_{rq} \qquad [ Eq . 19 ]$$

As the above-described mode-matching method, by applying the Neumann boundary condition (∂Φ/∂θ) between regions IV and II, and between regions IV and III, and simplifying the results by utilizing orthogonality, equations 20 and 21 are obtained.

$$\begin{matrix}{\sum }_{p = 1}^{∞} {{F}_{p} [ {T}_{p} ( cos {α}_{0} ) ]}^{′} {G}_{qp} ( - {ϕ}_{1} , - {l}_{1} , {b}_{q} , {a}_{p} ) = - {\sum }_{s = 1}^{∞} sin {α}_{0} [ {B}_{s} {P}_{0}^{{b}_{s} ′} ( cos {α}_{0} ) + {C}_{s} {Q}_{0}^{{b}_{s} ′} ( cos {α}_{0} ) ] ( \frac{{ϕ}_{1} - {l}_{1}}{2} ) {δ}_{sq} & [ Eq . 20 ] \\ {\sum }_{p = 1}^{∞} {{F}_{p} [ {T}_{p} ( cos {α}_{0} ) ]}^{′} {G}_{qp} ( {l}_{2} , {ϕ}_{2} , {c}_{q} , {a}_{p} ) = - {\sum }_{r = 1}^{∞} sin {α}_{0} [ {D}_{r} {P}_{0}^{{c}_{r} ′} ( cos {α}_{0} ) + {E}_{r} {Q}_{0}^{{c}_{r} ′} ( cos {α}_{0} ) ] ( \frac{{ϕ}_{2} - {l}_{2}}{2} ) {δ}_{rq} \\ Herein , \\ {[ {T}_{p} ( cos {α}_{0} ) ]}^{′} = - sin θ [ {Q}_{0}^{{a}_{p}} ( cos {α}_{2} ) {P}_{0}^{{a}_{p} ′} ( cos θ ) - {P}_{0}^{{a}_{p}} ( cos {α}_{2} ) {Q}_{0}^{{a}_{p} ′} ( cos θ ) ] {\vert}_{θ = {α}_{0}} . & [ Eq . 21 ]\end{matrix}$$

From equations 8, 12, 16, 19, 20 and 21, final simultaneous equations can be obtained with respect to the unknown modal coefficients. The simulation equations are expressed as equation 22 of a matrix equation.

$$[ \begin{matrix}{ψ}_{11} & {ψ}_{12} & {ψ}_{13} & {ψ}_{14} & {Ψ}_{15} & 0 \\ 0 & {ψ}_{22} & {ψ}_{23} & {ψ}_{24} & {ψ}_{25} & {ψ}_{26} \\ {ψ}_{31} & {ψ}_{32} & {ψ}_{33} & 0 & 0 & 0 \\ {ψ}_{41} & 0 & 0 & {ψ}_{44} & {ψ}_{45} & 0 \\ 0 & {ψ}_{52} & {ψ}_{53} & 0 & 0 & {ψ}_{56} \\ 0 & 0 & 0 & {ψ}_{64} & {ψ}_{65} & {ψ}_{66}\end{matrix} ] [ \begin{matrix}{A}_{p} \\ {B}_{s} \\ {C}_{s} \\ {D}_{r} \\ {E}_{r} \\ {F}_{p}\end{matrix} ] = [ \begin{matrix}Λ \\ Λ \\ 0 \\ 0 \\ 0 \\ 0\end{matrix} ] \qquad [ Eq . 22 ]$$

The elements of the matrix equation are expressed as below.

$${ψ}_{11} = {R}_{p} ( cos {α}_{d} ) \frac{{ϕ}_{2} + {ϕ}_{1}}{2} {δ}_{pq}$$

$${ψ}_{12} = - {P}_{0}^{{b}_{s}} ( cos {α}_{d} ) {G}_{sq} ( - {ϕ}_{1} , - {l}_{1} , {b}_{s} , {a}_{q} )$$

$${ψ}_{13} = - {Q}_{0}^{{b}_{s}} ( cos {α}_{d} ) {G}_{sq} ( - {ϕ}_{1} , - {l}_{1} , {b}_{s} , {a}_{q} )$$

$${ψ}_{14} = - {P}_{o}^{{c}_{r}} ( cos {α}_{d} ) {G}_{rq} ( {l}_{2} , {ϕ}_{2} , {c}_{r} , {a}_{q} )$$

$${ψ}_{15} = - {Q}_{o}^{{c}_{r}} ( cos {α}_{d} ) {G}_{rq} ( {l}_{2} , {ϕ}_{2} , {c}_{r} , {a}_{q} )$$

$${ψ}_{22} = - {P}_{0}^{{b}_{s}} ( cos {α}_{0} ) {G}_{sq} ( - {ϕ}_{1} , - {l}_{1} , {b}_{s} , {a}_{q} )$$

$${ψ}_{23} = - {Q}_{0}^{{b}_{s}} ( cos {α}_{0} ) {G}_{sq} ( - {ϕ}_{1} , - {l}_{1} , {b}_{s} , {a}_{q} )$$

$${ψ}_{24} = - {P}_{0}^{{c}_{r}} ( cos {α}_{0} ) {G}_{rq} ( {l}_{2} , {ϕ}_{2} , {c}_{r} , {a}_{q} )$$

$${ψ}_{25} = - {Q}_{0}^{{c}_{r}} ( cos {α}_{0} ) {G}_{rq} ( {l}_{2} , {ϕ}_{2} , {c}_{r} , {a}_{q} )$$

$${ψ}_{26} = {T}_{p} ( cos {α}_{0} ) \frac{{ϕ}_{2} + {ϕ}_{1}}{2} {δ}_{pq}$$

$${ψ}_{31} = {[ {R}_{p} ( cos {α}_{d} ) ]}^{′} {G}_{qp} ( - {ϕ}_{1} , - {l}_{1} , {b}_{q} , {a}_{p} )$$

$${ψ}_{32} = sin ( {α}_{d} ) {P}_{0}^{{b}_{s} ′} ( cos {α}_{d} ) ( \frac{{ϕ}_{1} - {l}_{1}}{2} ) {δ}_{sq}$$

$${ψ}_{33} = sin ( {α}_{d} ) {Q}_{0}^{{b}_{s} ′} ( cos {α}_{d} ) ( \frac{{ϕ}_{1} - {l}_{1}}{2} ) {δ}_{sq}$$

$${ψ}_{41} = {[ {R}_{p} ( cos {α}_{d} ) ]}^{′} {G}_{qp} ( {l}_{2} , {ϕ}_{2} , {c}_{q} , {a}_{p} )$$

$${ψ}_{44} = sin ( {α}_{d} ) {P}_{0}^{{c}_{r} ′} ( cos {α}_{d} ) ( \frac{{ϕ}_{2} - {l}_{2}}{2} ) {δ}_{rq}$$

$${ψ}_{45} = sin ( {α}_{d} ) {Q}_{0}^{{c}_{r} ′} ( cos {α}_{d} ) ( \frac{{ϕ}_{2} - {l}_{2}}{2} ) {δ}_{rq}$$

$${ψ}_{52} = sin {α}_{0} {P}_{0}^{{b}_{s} ′} ( cos {α}_{0} ) ( \frac{{ϕ}_{1} - {l}_{1}}{2} ) {δ}_{sq}$$

$${ψ}_{53} = sin {α}_{0} {Q}_{0}^{{b}_{s} ′} ( cos {α}_{0} ) ( \frac{{ϕ}_{1} - {l}_{1}}{2} ) {δ}_{sq}$$

$${ψ}_{56} = {[ {T}_{p} ( cos {α}_{0} ) ]}^{′} {G}_{qp} ( - {ϕ}_{1} , - {l}_{1} , {b}_{q} , {a}_{p} )$$

$${ψ}_{64} = sin {α}_{0} {P}_{0}^{{c}_{r} ′} ( cos {α}_{0} ) ( \frac{{ϕ}_{2} - {l}_{2}}{2} ) {δ}_{rq}$$

$${ψ}_{65} = sin {α}_{0} {Q}_{0}^{{c}_{r} ′} ( cos {α}_{0} ) ( \frac{{ϕ}_{2} - {l}_{2}}{2} ) {δ}_{rq}$$

$${ψ}_{66} = {[ {T}_{p} ( cos {α}_{0} ) ]}^{′} {G}_{qp} ( {l}_{2} , {ϕ}_{2} , {c}_{q} , {a}_{p} )$$

$$Λ = {I}_{q}^{1} - {I}_{q}^{2} + {P}_{q}$$

The unknown modal coefficients are obtained by using the matrix equation of equation 22, whereby distribution of equipotential line in the GTEM cell is obtained depending on each mode.

Moreover, in order to check the accuracy of the generated algorithm (including the equations), calculations in which k is assumed to be ω\sqrt{μ₀ε₀} are performed. For example, the TEM mode may be written as a program based on the above-described theory using mathematic theory of matrix or the like.

For example, in the embodiment of the present invention, the calculations are made on the structure of the GTEM cell in which septum is provided at an asymmetric position. Herein, both cases of a thin thickness and a relatively thicker thickness of the septum are considered in the calculations. In the case of the thin thickness of the septum, the structure of the GTEM cell is set for the calculations as follows: α₀=90°; α₁=78°; α₂=96°; α_{d}=89.7°; φ₁=φ₂=15°; l₁=l₂=9.75°; and V₀=1. In the case of the thick thickness of the septum, the thickness of the septum is set as α_{d}=87° and the other conditions of the structure are identical to those of the former.

The number of the modes used is ten for regions I and IV and two for regions II and III.

Table 1 shows values of |AₚRₚ(cos θ)| in the TEM mode (α_{d}=89.7°, θ=85°) and it is seen that the values of |AₚRₚ(cos θ)| rapidly converge.

TABLE 1

| | \|AₚRₚ(cosθ)\| |
|---|---|
| p = 1 | 0.610867 |
| p = 3 | 0.0427918 |
| p = 5 | 0.00371483 |
| p = 7 | 0.00297096 |
| p = 9 | 0.000706794 |

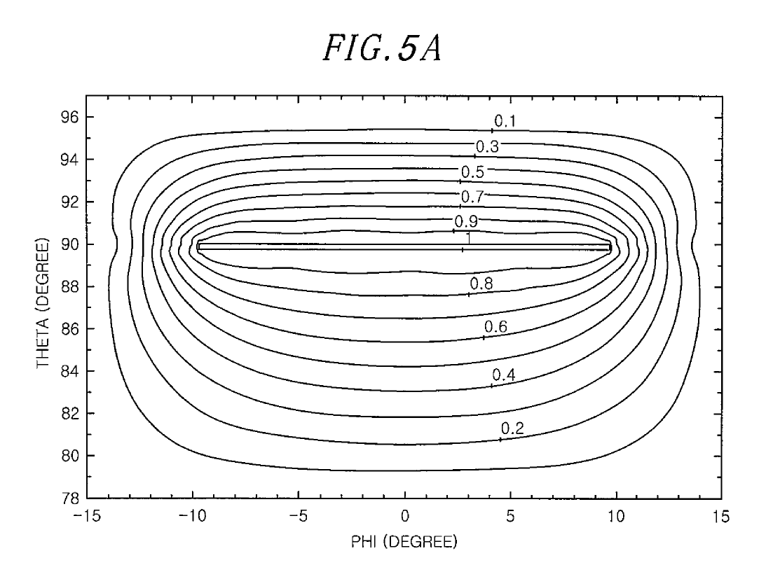

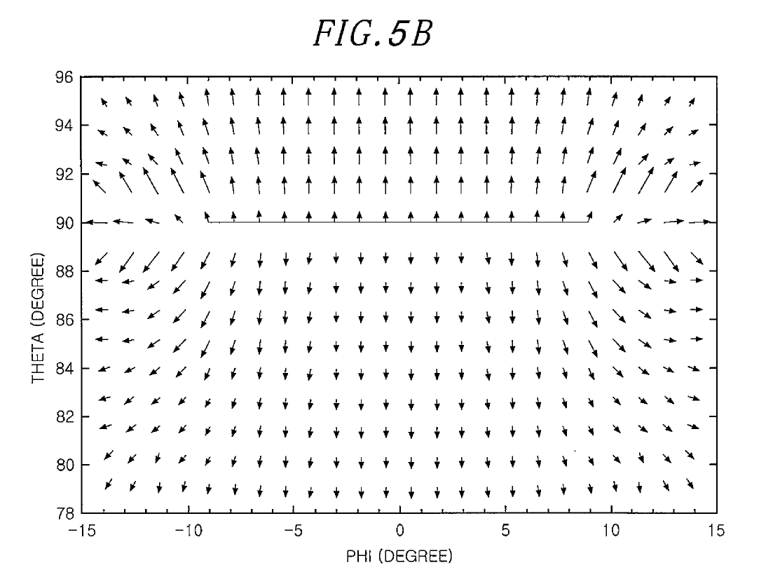

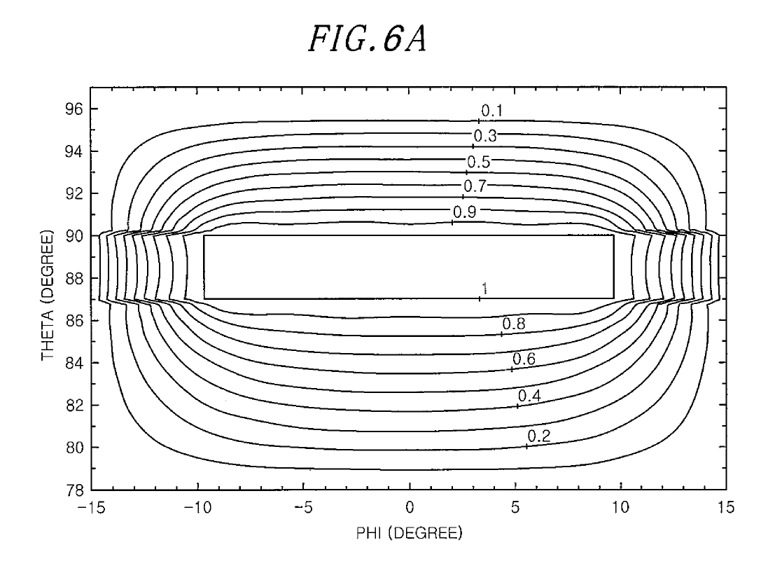

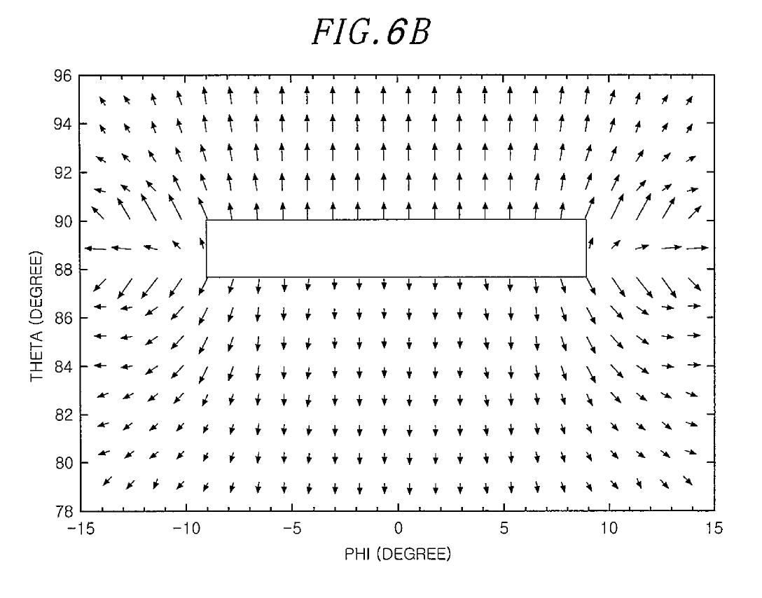

FIGS. 5A to 5B depict the distribution of the equipotential lines and E-field distribution which is presented with arrows at a cross section φ−θ where r is constant, in a case of α_{d}=89.7°, and FIGS. 6A and 6B present the same in a case of α_{d}=87°.

By referring to FIGS. 5A to 6B, the distribution of the equipotential lines depending on the thickness of the septum is observed, whereby the distribution of the E-field depending on the thickness of the septum can be clearly confirmed.

As described above, the analysis algorithm generation apparatus and method generates the algorithm for analyzing TEM mode distribution in a cross section of the tapered section of the TEM cell or GTEM cell, which is used as an electromagnetic field generator in the EMC field, by using the associated Legendre function and the mode-matching method, and for designing the structure of the TEM cell or the GTEM cell based on the analysis result.

While the invention has been shown and described with respect to the particular embodiments, it will be understood by those skilled in the art that various changes and modification may be made without departing from the scope of the invention as defined in the following claims.

What is claimed is:

1. An analysis algorithm generation apparatus of an electromagnetic field generator comprising:
a value inputting unit for receiving information on a TEM cell or GTEM cell; and
an algorithm generating unit for generating an algorithm to analyze a TEM mode in a cross sectional structure of the GTEM cell or a tapered section of the TEM cell by using an associated Legendre function and a mode-matching method based on the information transmitted from the value inputting unit.

2. The apparatus of claim 1, wherein the algorithm generating unit analyzes the TEM mode by dividing a space into four (left, right, upper and lower) regions, the space existing between an inner electrode and an outer wall of the cross sectional structure of the GTEM cell or the tapered section of the TEM cell.

3. The apparatus of claim 2, wherein the algorithm generating unit derives electrostatic potentials of the four regions by using Laplace's equation.

4. The apparatus of claim 3, wherein the algorithm generating unit expresses the electrostatic potentials of the four regions in six modal coefficients which are used to derive six simultaneous equations by applying a Dirichlet boundary condition and a Neumann boundary condition at boundary surfaces of the inner electrode with respect to the upper and the lower regions.

5. The apparatus of claim 4, wherein the algorithm generation unit applies the Dirichlet boundary condition between the upper and the left regions, between the upper and the right regions and between the upper region and the electrode.

6. The apparatus of claim 4, wherein the algorithm generation unit applies the Dirichlet boundary condition between the lower and the left regions, between the lower and the right regions and between the lower region and the electrode.

7. The apparatus of claim 4, wherein the algorithm generation unit applies the Neumann boundary condition between the upper and the left regions and between the upper and the right regions among the four regions.

8. The apparatus of claim 4, wherein the algorithm generation unit applies the Neumann boundary condition between the lower and the left regions and between the lower and the right regions among the four regions.

9. The apparatus of claim 4, wherein the algorithm generation unit derives a matrix equation with the six simultaneous equations, and obtains the electrostatic potentials by obtaining the six modal coefficients from the matrix equation.

10. The apparatus of claim 1, further comprising a value setting unit for transmitting information including previously set numerical values or defined conditions to the algorithm generation unit.

11. An analysis algorithm generation method of an electromagnetic field generator comprising:
receiving information on a TEM cell or GTEM cell; and
generating an algorithm to analyze a TEM mode in a cross sectional structure of the GTEM cell or a tapered section of the TEM cell by using an associated Legendre function and a mode-matching method based on the received information.

12. The method of claim 11, wherein said generating the algorithm includes analyzing the TEM mode by dividing a space into four (left, right, upper and lower) regions, the space existing between an inner electrode and an outer wall of the cross sectional structure of the GTEM cell or the tapered section of the TEM cell.

13. The method of claim 12, wherein, in said generating the algorithm, electrostatic potentials of the four regions are derived by using Laplace's equation.

14. The method of claim 13, wherein, in said generating the algorithm, the electrostatic potentials of the four regions are expressed in six modal coefficients which are used to derive six simultaneous equations by applying a Dirichlet boundary condition and a Neumann boundary condition at boundary surfaces.

15. The method of claim 14, wherein, in said generating the algorithm, the Dirichlet boundary condition is applied between the upper and the left regions, between the upper and the right regions and between the upper region and the electrode.

16. The method of claim 14, wherein, in said generating the algorithm, the Dirichlet boundary condition is applied between the lower and the left regions, between the lower and the right regions and between the lower region and the electrode.

17. The method of claim 14, wherein, in said generating the algorithm, the Neumann boundary condition is applied between the upper and the left regions and between the upper and the right regions among the four regions.

18. The method of claim 14, wherein, in said generating the algorithm, the Neumann boundary condition is applied between the lower and the left regions and between the lower and the right regions among the four regions.

19. The method of claim 14, wherein, in said generating the algorithm, a matrix equation is derived with the six simultaneous equations, and the electrostatic potentials are derived by obtaining the six modal coefficients from the matrix equation.

20. The method of claim 11, further comprising receiving information including previously set numerical values or defined conditions to be used in said generating the algorithm.
